(19) United States
(12) Patent Application Publication
(10) Pub. No.: US 2009/0233776 A1
(43) Pub. Date: Sep. 17, 2009

(54) CONDUCTIVE ROLLER

(75) Inventors: Yoshihisa Mizumoto, Kobe-shi (JP); Noriaki Hitomi, Kakogawa-shi (JP); Hirotoshi Murakami, Kakogawa-shi (JP); Yajun Zhang, Kakogawa-shi (JP)

Correspondence Address: BIRCH STEWART KOLASCH & BIRCH, PO BOX 747, FALLS CHURCH, VA, 22040-0747, US

(73) Assignee: Sumito Rubber Industries, Ltd., Kobe-shi (JP)

(21) Appl. No.: 12/403,814

(22) Filed: Mar. 13, 2009

(30) Foreign Application Priority Data
Mar. 14, 2008 (JP) 2008-066651

(51) Int. Cl. B05C 1/08; G03G 15/08

(52) U.S. Cl. 492/18; 399/286

(57) ABSTRACT

A conductive roller comprising a toner-transporting portion, made of a vulcanized rubber composition, which is disposed at least on an outermost layer thereof. The vulcanized rubber composition contains a rubber component (A) mixed with a weakly conductive carbon black (B) having a large particle diameter not less than 80 nm nor more than 500 nm, a highly conductive carbon black (C) having a small particle diameter not less than 18 nm nor more than 80 nm, and an inorganic filler (D) consisting of not less than one kind of a metal oxide selected from among a group of titanium oxide, alumina, and silica. The total of a mixing amount of the weakly conductive carbon black (B), that of the highly conductive carbon black (C), and that of the inorganic filler (D) for 100 parts by mass of the rubber component (A) is not less than 15 parts by mass nor more than 60 parts by mass.

This nonprovisional application claims priority under 35 U.S.C. § 119(a) on Patent Application No(s). 2008-066651 filed in Japan on Mar. 14, 2008, the entire contents of which are hereby incorporated by reference.

### BACKGROUND OF THE INVENTION

1. Field of the Invention

The present invention relates to a conductive roller and more particularly to the conductive roller, having a toner-transporting portion, which is used as a developing roller, a cleaning roller, a charging roller, a transfer roller, and the like mounted on an electrophotographic apparatus. The conductive roller is so constructed that toner can be separated therefrom by restraining the transport of an excessive amount of toner and that excellent printing performance can be performed for a long time.

2. Description of the Related Art

In the printing technique using an electrophotographic method, a high-speed printing operation, formation of a high-quality image, formation of a color image, and miniaturization of image-forming apparatuses have been progressively made and become widespread. Toner holds the key to these improvements. To satisfy the above-described demands, it is necessary to form finely divided toner particles, make the diameters of the toner particles uniform, and make the toner particles spherical. Regarding the technique of forming the finely divided toner particles, toner having a diameter not more than 10 μm and toner not more than 5 μm have been developed recently. Regarding the technique of making the toner spherical, toner having not less than 99% in its deviation from a spherical form has been developed. To form the high-quality image, polymerized toner has come to be widely used instead of pulverized toner conventionally used. The polymerized toner allows the reproduction of dots to be excellent in obtaining printed matters from digital information and hence a high-quality printed matter to be obtained.

In compliance with the improvement in the technique of forming the finely divided toner particles, making the diameters of the toner particles uniform, making the toner particles spherical, and the shift from the pulverized toner to the polymerized toner, in an image-forming apparatus of an electrophotographic apparatus such as a laser beam printer, and the like, there is a demand for the development of a conductive roller which imparts a high electrostatic charging property to toner and is capable of transporting the toner to a photosensitive drum without adhesion of the toner to the conductive roller. A conductive roller having an electric resistance value adjusted to not more than 10⁸Ω is especially useful. Users demand that the high-performance function of the conductive roller is maintained to the end of the life of a product.

To solve these problems, the present inventors have proposed the following rubber rollers:

The present applicant proposed a rubber roller described below to solve the above-described problem.

Proposed as disclosed in Japanese Patent Application Laid-Open No. 2007-286236 (patent document 1) is the semiconductive roller composed of the surface layer having a high electric resistance value made of the rubber composition and the base layer, having a low electric resistance value, made of the electroconductive rubber composition. The semiconductive roller is intended to obtain a favorable electrostatic charging characteristic by favorably balancing the electric resistance value of the surface layer and that of the base layer. It is necessary to make the thickness of both layers highly accurate. To form the thickness of both layers highly accurate, troublesome management is required, and the cost for producing the rubber roller is high because the yield is low even though the management is made. Thus there is room for improvement for producing the roller at a low cost by a simple process management.

Described in Japanese Patent Application Laid-Open No. 2006-99036 (patent document 2) is the semiconductive rubber member, having the conductive rubber layer containing chloroprene rubber disposed on an outermost layer, which has a dielectric loss tangent of 0.1 to 1.8. The semiconductive rubber member is capable of imparting a very high electric charge to materials such as toner which sticks thereto and preventing the leak of an electric charge imparted to the toner.

In the semiconductive rubber member, the above-described requirement is satisfied and the kind of the rubber component and that of the carbon black are adjusted. Thereby the semiconductive rubber member achieves the improvement of the initial image density and durability (stability with age in charging toner) at a very high level. But there is room for improvement in achieving both the initial image density and durability at the same time at a very high level.

Described in Japanese Patent Application Laid-Open No. 2004-170845 (patent document 3) is the conductive rubber roller composed of the ionic-conductive rubber, having a uniform electrical characteristic, which contains a dielectric loss tangent-adjusting filler to adjust the dielectric loss tangent thereof at 0.1 to 1.5. The conductive rubber roller is capable of imparting a proper and high electrostatic charging property to toner, thereby providing a high-quality initial image. In the conductive rubber roller, the charged amount of the toner little decreases even after printing of a considerable number of sheets finishes. Consequently the conductive rubber roller keeps providing a high-quality image for a long time.

As disclosed in the patent document 3, a rubber component, represented by epichlorohydrin rubber, which contains chlorine atoms is used for the conductive rubber roller to allow the conductive rubber roller to be ionic-conductive. In this case, the rubber component containing the chlorine atoms has a high surface free energy. Thus the rubber component containing the chlorine atoms is liable to adhere to the toner and an additive for the toner.

When the rubber component containing the chlorine atoms is polymerized with an ionic-conductive ethylene oxide monomer, the conductive roller has a high surface free energy and is liable to get wet. Thereby the adhesion of the toner to the conductive rubber roller becomes high.

When an oxide film is formed on the surface of the conductive rubber roller by irradiating the surface thereof with ultraviolet rays or exposing it to ozone, the oxygen concentration of the surface of the conductive rubber roller becomes high. Thus the surface free energy increases. Thereby the adhesion of the toner to the conductive rubber roller further increases.

When the dielectric loss tangent of the conductive rubber roller is set to 0.1 to 1.5, it is possible to improve the electrostatic property of the toner and hence decrease the transport amount of the toner. Thus the conductive rubber roller provides a high-quality image such as a half-tone image. In this case, the amount of the toner deposited on a developing roller decreases. Thereby when the conductive rubber roller is used as a developing roller, the adhesion of the toner to the conductive rubber roller further increases.

The toner which has adhered to the conductive rubber roller does not considerably affect images formed in an early stage and when images are successively printed. But when images are printed in the following conditions (1) through (4), the influence of the toner that has adhered to the conductive rubber roller cannot be ignored. For example, normally, charged toner is transported to a photosensitive drum having an opposite electric charge by an electrostatic force (Coulomb force). But the transport of the toner by the static electricity is prevented because the adhesion of the toner to the developing roller is high. Thus there arises a problem that the print density becomes low, although the charged amount applied to the toner does not change.

(1) When printing is made on a considerable number of sheets of paper and hence toner has an affinity for the developing roller (for example, when image is printed at 1% on about 2,000 sheets of paper).

(2) When an average particle diameter of toner is not more than 8 μm and particularly not more than 6 μm.

(3) When printing is made not successively, but is suspended for a day and made the next day.

(4) When the developing roller is used in a low-temperature and low-humidity environment in which the charged amount of toner is comparatively large.

Disclosed in Japanese Patent Application Laid-Open No. 2005-225969 (patent document 4) is the semiconductive rubber member composed of the ionic-conductive rubber component containing the rubber having the polyether bond. Wax is added to the rubber component of the ionic-conductive rubber to decrease the surface free energy so that the additive for toner or the like can be prevented from adhering to the semiconductive rubber member for a long time. Further the semiconductive rubber member is excellent in its processability and prevent nonuniformity when it is molded and preventing the formation of a defective surface such as a cracked surface.

But when the semiconductive rubber member is used as the developing roller, a large amount of toner adheres thereto, which causes “decrease in print density”. In addition, there is a slight degree of contamination on the toner and a photosensitive drum owing to the presence of a component having a low-molecular weight component caused by bleed of wax or the like and owing to the adhesiveness of the toner in environment having a comparatively high temperature (about 50° C.). Therefore when the semiconductive rubber member is used for a printer or the like demanded to provide a high-quality image, the kind of rubber or polymer which can be used for the semiconductive rubber member is limited. Thus there is room for improvement in the semiconductive rubber member.

Patent document 1: Japanese Patent Application Laid-Open No. 2007-286236

Patent document 2: Japanese Patent Application Laid-Open No. 2006-99036

Patent document 3: Japanese Patent Application Laid-Open No. 2004-170845

Patent document 4: Japanese Patent Application Laid-Open No. 2005-225969

When the above-described conductive roller is used as the developing roller, the physical adherence of the toner to the developing roller is high. Therefore although the charged toner has a state in which it is transported to a photosensitive drum having an opposite electric charge by an electrostatic force (Coulomb force), the high adherence to the developing roller prevents the toner from being transported. Thus although there is no change in the charged amount applied to the toner, print density drops, i.e., a problem of “drop of developing efficiency” occurs. As described above, there is a tendency that the developing efficiency drops although there is a large amount of the toner which can be transported. This tendency is conspicuous in a high-speed printer having a speed of not less than 20 rpm.

When the developing efficiency drops, a large amount of toner circulates in a toner box, which causes the toner to deteriorate. Consequently the drop in the charged amount of the toner is accelerated. As a result, there occurs a problem that defective images are formed. That is, when the developing roller transports a large number of toner mainly because of the unfavorable electrostatic and physical separation of the toner from the developing roller, most of toner transported by the developing roller does not contribute to printing to be made by the photosensitive drum, but remains in the developing roller and returns to the toner box. As a result, the toner repeatedly circulates within the toner box, and the deterioration (damaged by rubbing and the like) of the toner is accelerated to generate defective images in a later period of time of a durable use.

### SUMMARY OF THE INVENTION

It is an object of the present invention to provide a conductive roller which restrains the transport of an excessive amount of toner, achieves favorable separation of the toner therefrom, maintains a proper degree of a print density, and is excellent in its printing performance for a long time.

To solve the above-described problem, the present invention provides a conductive roller comprising a toner-transporting portion, made of a vulcanized rubber composition, which is disposed at least on an outermost layer thereof. The vulcanized rubber composition contains a rubber component (A) mixed with a weakly conductive carbon black (B) having a large particle diameter not less than 80 nm nor more than 500 nm, a highly conductive carbon black (C) having a small particle diameter not less than 18 nm nor more than 80 nm, and an inorganic filler (D) consisting of not less than one kind of a metal oxide selected from among a group of titanium oxide, alumina, and silica. The total of a mixing amount of the weakly conductive carbon black (B), that of the highly conductive carbon black (C), and that of the inorganic filler (D) for 100 parts by mass of the rubber component (A) is not less than 15 parts by mass nor more than 60 parts by mass.

The toner-transporting portion constructing the outermost layer of the conductive roller of the present invention essentially contains the three kinds of the fillers (B), (C), and (D) to be mixed with the rubber component (A).

The following problems occur when the fillers (B), (C), and (D) are separately mixed with the rubber component (A) as done in the methods disclosed in the patent documents 1 through 4.

When not less than 20 parts by mass of only the weakly conductive carbon black (B) having the large particle diameter is mixed with 100 parts by mass of the rubber component (A) as the filler, it is possible to provide toner with a high initial charged amount. But there occurs a problem that the toner has a very high electrostatic adhesive force.

When not less than 20 parts by mass of only the highly conductive carbon black (C) having the small particle diameter is mixed with 100 parts by mass of the rubber component (A) as the filler, the conductive rubber is capable of providing a high print density. But the conductivity of the conductive rubber is so high that it is incapable of charging the toner to a high extent.

When only the inorganic filler (D) consisting of the metal oxide is mixed with the rubber component (A) as the filler, the conductive rubber is capable of obtaining an effect of decreasing a physical adhesive force of the toner, but is incapable of charging the toner to a high extent and is thus incapable of providing a sufficient print density.

As described above, in separately mixing the fillers (B) through (D) with the rubber component (A), it is necessary to use a large amount thereof. In addition, there occurs a problem that “decrease of adhesive force of toner (transport amount of toner)”, “charged amount of toner and maintenance thereof”, and “maintenance of proper degree of print density” constitute contradictory performances. All of these performances cannot be achieved at the same time. In this case, the conductive roller is insufficient in the entire performance thereof.

But in the present invention, the total amount of the fillers (B), (C), and (D) for 100 parts by mass of the rubber component (A) is not less than 15 parts by mass nor more than 60 parts by mass. Therefore it is possible to achieve the above-described contradictory performances simultaneously and the production of the conductive roller having excellent entire performance. The fillers (B), (C), and (D) show excellent dispersibility for the rubber component (A). Thus it is possible to use the fillers (B), (C), and (D) in a comparatively small amount. Consequently it is possible to prevent the hardness of the conductive roller from increasing, efficiencies in development and the like from deteriorating, other members of an electrophotographic apparatus such as a photosensitive drum from being mechanically damaged, and the toner from being deteriorated.

The outermost layer of the toner-transporting portion of the conductive roller of the present invention is made essentially of the vulcanized rubber. Therefore unlike the technique of coating the surface of the conductive roller, it is possible to obtain the uniformity of the electric characteristic thereof and the reproducibility of designed values at a low cost.

When the total amount of the fillers (B), (C), and (D) is less than 15 parts by mass for 100 parts by mass of the rubber component (A), it is impossible to obtain the effect of mixing the fillers (B), (C), and (D) with the rubber component (A) sufficiently. When the total amount of the fillers (B), (C), and (D) is more than 40 parts by mass for 100 parts by mass of the rubber component (A), the conductive roller has a high hardness. Thus there is a fear that the toner deteriorates. It is preferable to set the total of the mixing amount of the fillers (B), (C), and (D) to not less than 15 parts by mass nor more than 40 parts by mass for 100 parts by mass of the rubber component (A).

In the present invention, carbon black having the large particle diameter of not less than 80 nm nor more than 500 nm is defined as the “weakly conductive carbon black (B)”, whereas carbon black having the small particle diameter of not less than 18 nm nor more than 80 nm is defined as the “highly conductive carbon black (C)”.

There is a conspicuous difference between the conductivity of the carbon black having a particle diameter less than 80 nm and that of the carbon black having a particle diameter more than 80 nm. The weakly conductive carbon black (B) and the highly conductive carbon black (C) play different roles when they are contained in the vulcanized rubber composition.

The weakly conductive carbon black has a comparatively large particle diameter, a low extent of development in its structure, and a low extent of contribution to the conductivity of the conductive rubber composition. The conductive rubber composition containing the weakly conductive carbon black is capable of obtaining a capacitor-like operation owing to a polarizing action without increasing the conductivity of the conductive rubber and controlling the electrostatic charging property to be imparted to the toner without deteriorating the uniformity of the electric resistance thereof.

The highly conductive carbon black (C) has a smaller particle diameter than the weakly conductive carbon black (B), a high extent of development in its structure, and a high extent of contribution to the conductivity of the conductive rubber composition. The conductive rubber composition containing the highly conductive carbon black (C) is capable of having a high conductivity. For example, when the conductive roller containing the highly conductive carbon black (C) is used as a developing roller, a high print density can be obtained, even though the area of contact between the developing roller and the photosensitive drum is small, because a printer has a high speed and a period of time in which the developing roller contacts the photosensitive drum is short, or because a printer is compact and the diameter of the photosensitive drum is small.

It is possible to obtain the above-described effect more efficiently by using the weakly conductive carbon black (B) having a particle diameter of not less than 100 nm. The surface roughness can be decreased when the particle diameter of the weakly conductive carbon black (B) is not more than 500 nm and preferably not more than 250 nm. Because the weakly conductive carbon black (B) has a small surface area, it is preferable that the weakly conductive carbon black (B) is spherical or approximately spherical.

In the present specification, “particle diameter” means “primary particle diameter”.

It is favorable to mix not less than 1 nor more than 40 parts by mass of the weakly conductive carbon black (B) with 100 parts by mass of the rubber component (A). When the mixing ratio of the weakly conductive carbon black (B) is less than one, it is impossible to obtain a sufficient initial charged amount and electrostatic adhesive force of toner. When the mixing ratio of the weakly conductive carbon black (B) is more than 40, the electrostatic adhesive force of the toner is too high and the conductive roller has a high hardness.

As the lower limit of the mixing ratio of the weakly conductive carbon black (B), it is more favorable to mix not less than 2.5 parts by mass thereof with 100 parts by mass of the rubber component (A). As the upper limit of the mixing ratio of the weakly conductive carbon black (B), it is more favorable to mix not more than 20 parts by mass thereof and most favorable to mix not more than 15 parts by mass thereof with 100 parts by mass of the rubber component (A).

Various weakly conductive carbon blacks (B) can be selected within the above-described particle diameter range. For example, it is favorable to use carbon black produced by a furnace method or a thermal method capable of providing particles having large diameters. It is more favorable to use carbon black produced by the furnace method. SRF carbon (60 to 95 nm), FT carbon (80 to 500 nm), and MT carbon (80 to 500 nm) are preferable in terms of the classification of carbon. Carbon black for use in pigment may be used.

It is favorable to use the weakly conductive carbon black (B) having an iodine adsorption amount of 10 to 40 mg/g and more favorable to use the weakly conductive carbon black (B) having the iodine adsorption amount of 10 to 30 mg/g. It is favorable to use the weakly conductive carbon black (B) having a DBP oil absorption amount of 25 to 90 ml/100 g and more favorable to use the weakly conductive carbon black (B) having the DBP oil absorption amount of 25 to 55 ml/100 g.

It is preferable to mix not less than 1 nor more than 40 parts by mass of the highly conductive carbon black (C) with 100 parts by mass of the rubber component (A). When the mixing ratio of the highly conductive carbon black (C) is less than one part by mass, the conductive rubber is incapable of having a high conductivity. Thus the conductive roller is incapable of providing a high print density. When the mixing ratio of the highly conductive carbon black (C) is more than 40 parts by mass, the conductivity of the conductive roller is so high that the conductive roller is incapable of sufficiently charging the toner. Further because the conductive roller has a high hardness, there is a fear that the toner deteriorates.

As the lower limit of the mixing ratio of the highly conductive carbon black (C) for 100 parts by mass of the rubber component (A), the mixing ratio thereof is favorably not less than 5 parts by mass and more favorably not less than 10 parts by mass. As the upper limit of the mixing ratio of the highly conductive carbon black (C) for 100 parts by mass of the rubber component (A), the mixing ratio thereof is favorably not more than 30 parts by mass and more favorably not more than 25 parts by mass.

As the highly conductive carbon black (C) having a small particle diameter, it is possible to use various kinds of carbon black in the above-described particle diameter range. It is possible to list conductive carbon black such as Ketchen black, furnace black, and acetylene black.

It is preferable to use carbon in the above-described particle diameter range such as SAF carbon (average particle diameter: 18 to 22 nm), SAF-HS carbon (average particle diameter: about 20 nm), ISAF carbon (average particle diameter: 19 to 29 nm), N-339 carbon (average particle diameter: about 24 nm), ISAF-LS carbon (average particle diameter: 21 to 24 nm), I-ISAF-HS carbon (average particle diameter: 21 to 31 nm), HAF carbon (average particle diameter: about 26 to 30 nm), HAF-HS carbon (average particle diameter: 22 to 30 nm), N-351 carbon (average particle diameter: about 29 nm), HAF-LS carbon (average particle diameter: about 25 to 29 nm), LI-HAF carbon (average particle diameter: about 29 nm), MAF carbon (average particle diameter: 30 to 35 nm), FEF carbon (average particle diameter: about 40 to 52 nm), SRF carbon (average particle diameter: not less than 58 nm), SRF-LM carbon, and GPF carbon (average particle diameter: not less than 49 nm) are listed. Above all, the FEF carbon, the ISAF carbon, the SAF carbon, and the HAF carbon are preferable.

As the inorganic filler (D) consisting of the metal oxide, at least one kind selected from among the group of the titanium oxide, the alumina, and the silica is used according to the kind of the rubber component (A) and a desired property of the conductive roller. Two or three kinds of fillers may be used in combination as the inorganic filler (D). The titanium oxide can be used especially favorably because the titanium oxide is dispersible with the weakly conductive carbon black (B).

It is favorable to mix not less than 1 nor more than 40 parts by mass of the inorganic filler (D) with 100 parts by mass of the rubber component (A). When the mixing ratio of the inorganic filler (D) is less than one part by mass, the physical adherence of the toner to the conductive roller is high, i.e., the toner cannot be easily separated from the conductive roller. When the mixing ratio of the inorganic filler (D) is more than 40 parts by mass, the toner-transporting portion has a very high hardness or the toner cannot be appropriately charged.

As the lower limit of the mixing ratio of the inorganic filler (D) for 100 parts by mass of the rubber component (A), it is more favorable to mix not less than 2 parts by mass of the inorganic filler (D) and most favorable to mix not less than 5 parts by mass thereof with 100 parts by mass of the rubber component (A). As the upper limit of the mixing ratio of the inorganic filler (D) for 100 parts by mass of the rubber component (A), it is more favorable to mix not more than 20 parts by mass of the inorganic filler (D) with 100 parts by mass of the rubber component (A).

It is preferable that the particle diameter of the inorganic filler (D) consisting of the titanium oxide, the alumina or the silica is smaller than that of the toner used in the present invention. For example, it is favorable that the primary particle diameter of the inorganic filler (D) is not more than 10 μm. In consideration of the cost of the inorganic filler (D) and mixability thereof, the primary particle diameter thereof is favorably not less than 1 nm and more favorably not less than 10 nm in consideration of the dispersibility of the inorganic filler (D) with other fillers. The primary particle diameter of the inorganic filler (D) is more favorably not more than 5 μm in consideration of action thereof on the toner. In consideration of both the cost and performance of the inorganic filler (D), the primary particle diameter thereof is favorably not less than 50 nm nor more than 1000 nm and more favorably not less than 100 nm nor more than 500 nm.

The type of the titanium oxide which is used in the present invention is not limited to a specific type, but known types can be used. As a crystalline type, it is possible to use any of an anatase type, a rutile type, a mixture of these two types, and an amorphous type. It is preferable to use the titanium oxide of the rutile type. The titanium oxide is obtained by a sulfuric acid method, a chlorine method; and low-temperature oxidation (thermal decomposition, hydrolysis) of volatile titanium compounds such as titanium alcoxide, titanium halide or titan acetylacetonate, and the like.

It is favorable that the titanium oxide used in the present invention contains particles whose diameters are not more than 500 nm at not less than 50%. In this case, the titanium oxide has a favorable dispersibility. It is favorable to use the titanium oxide whose particle diameters are in the range of 100 to 500 nm in average.

It is especially favorable to use the titanium oxide of the rutile type containing particles whose diameters are in the range of 300 to 500 nm in average as its main component.

The kind of the silica used in the present invention is not limited to a specific kind, but silica commercially available can be used. As the silica commercially available, “Nipseal VN3 (commercial name)” produced by Tosoh Silica Corporation is exemplified. The silica may be surface-treated according to the property of the toner. As the surface treatment, hydrophobic treatment and hydrophilic treatment are exemplified.

It is especially preferable that the average primary particle diameter of the silica is 10 to 500 nm. The silica having a BET specific surface area of 30 to 300 m²/g is favorable. The silica having the BET specific surface area of 60 to 250 m²/g is more favorable.

The alumina is an oxide (Al₂O₃) of aluminum.

It is favorable that the alumina which is used in the present invention contains particles having the primary diameter of not more than 1 μm at not less than 80%. It is more favorable that the alumina which is used in the present invention contains particles having the primary diameter of not more than 0.5 μm at not less than 50%. By using the alumina having a small particle diameter, it is possible to disperse it uniformly in the toner-transporting portion. Thereby it is possible to improve the heat dissipation effect described below and easily secure the uniformity of the surface of the toner-transporting portion.

The alumina is excellent in the thermal conductivity thereof. Thus when the alumina is contained in the toner-transporting portion, it is possible to rapidly disperse heat generated by friction between the sealing portion of the conductive roller and the peripheral surface of the toner-transporting portion thereof to the entire toner-transporting portion. It is possible to dissipate heat transmitted to the inside of the toner-transporting portion to the outside via the core made of a metal and from the surface of the toner-transporting portion containing the alumina. Therefore it is possible to refrain the wear of the sealing portion from being accelerated by heat generated owing to the sliding friction between the sealing portion and the toner-transporting portion, thus effectively preventing the leak of the toner for a long time.

In addition, the temperature of the toner-transporting portion does not become high by the heat generated in the portion where the sealing portion and the toner-transporting portion slide on each other. Therefore it is possible to prevent thermoplastic resin constructing a pulverized toner from being fused and toner particles from having a large diameter and the edges thereof from being sharpened and welded to each other. Thereby it is possible to prevent them from becoming large and angular. Thereby it is possible to much improve the durability of the sealing portion and the toner-transporting portion. In addition, when the alumina and the titanium oxide are simultaneously mixed with each other, the mixing efficiency of the titanium oxide increases. For example, the alumina and the titanium oxide are hardly detected as a foreign matter on the surface of rubber.

From the stand point of thermal conductivity, the alumina is contained at not less than 2.5 nor more than 40 parts by mass and favorably not more than 30 parts by mass and more favorably not more than 25 parts by mass for 100 parts by mass of the rubber component (A). The reason the alumina is contained at not less than 2.5 in 100 parts by mass of the rubber component (A) is as follows: When the mixing ratio of the rubber component (A) is less than 2.5 parts by mass, it is difficult to obtain the effect of dissipating the heat generated by the sliding friction between the sealing portion and the toner-transporting portion. On the other hand, when the content of the alumina is more than 40 parts by mass, the hardness of the toner-transporting portion is so high that the toner acceleratedly deteriorates and an abrasion material for abrading the surface of the toner-transporting portion has a low durability. Thus re-dressing is necessary. When the content of the alumina is set to not more than 30 parts by mass, the alumina favorably mixes with the weakly conductive carbon black (B) and the highly conductive carbon black (C).

It is preferable to set the mixing amount of the highly conductive carbon black (C) larger than that of the weakly conductive carbon black (B) and not less than that of the inorganic filler (D) consisting of the above-described metal oxide.

Setting the mixing ratio of the highly conductive carbon black (C) to the above-described range has an advantage of simultaneously achieving the performances of “decrease of adhesive force of toner (transport amount of toner)”, “charged amount of toner and maintenance thereof”, and “maintenance of proper degree of print density”.

It is preferable that the rubber component (A) of the vulcanized rubber composition satisfies at least one of requirements (1) through (4) described below.

(1) Rubber having chlorine atoms;

(2) Rubber whose SP value is not less than 18.0 (MPa)^{1/2};

(3) Ionic-conductive rubber;

(4) Ionic-conductive rubber containing an ionic-conductive material.

(1) As the rubber having chlorine atoms, known rubbers can be used, provided that they have the chlorine atoms. More specifically, an unconductive rubber such as chloroprene rubber, chlorinated butyl, chlorosulfonated polyethylene, and the like little showing conductivity; and a conductive rubber such as epichlorohydrin copolymers are listed.

The rubber having the chlorine atoms has a characteristic that it is capable of very easily charging toner to be positively charged, but the chlorine atoms causes it to have a larger adhesive force than rubber not having the chlorine atoms. Therefore when the rubber component (A) contains the rubber having the chlorine atoms, it is possible to effectively restrain a high non-electrostatic adhesion and an electrostatic adhesive force which are defects of the rubber having the chlorine atoms by applying the present invention thereto.

When the unconductive rubber is used as the rubber having the chlorine atoms, it is preferable to combine the unconductive rubber with the ionic-conductive rubber in order to make the outermost layer ion-conductive. As the ionic-conductive rubber, copolymers such as polyether copolymers and epichlorohydrin copolymers containing ethylene oxide therein are listed. When the conductive rubber is used as the rubber having the chlorine atoms, the conductive rubber may be combined with the ionic-conductive rubber not having the chlorine atoms.

(2) As “the rubber having the SP value not less than 18.0 (MPa)^{1/2}”, it is possible to list the epichlorohydrin copolymers, the polyether copolymers, acrylic rubber, NBR having the amount of acrylonitrile not less than 20% and chloroprene rubber.

The SP value means a solubility parameter or a solubility constant. As is defined in a book “Flow of paint and dispersion of pigment” (compiled by Kenji Ueki and published by Kyoritsu Publishing Co., Ltd.), the SP value is the square root of a cohesive energy density of each liquid and serves as an index characterizing the solubility. The higher the SP value is, the higher the polarity is. In blending two or more kinds of rubbers with each other, rubber having the SP value less than 18.0 (MPa)^{1/2} may be used, but the mixing amount thereof is so adjusted that an apparent SP value thereof is not less than 18.0 (MPa)^{1/2}. The apparent SP value is obtained by computing the product of an SP value inherent in each rubber component and a mixing ratio of each rubber component when the entire rubber component is supposed to be 1 and finding the sum of the products. For example, supposing that the SP value of a component a is Xa, that the mixing ratio thereof is Ya when the entirety is supposed to be 1, that the SP value of a component b is Xb, and that the mixing ratio thereof is Yb when the entire rubber component is supposed to be 1, the apparent SP value is Xa·Ya+Xb·Yb.

By selecting the kind of rubber, “the rubber having the SP value not less than 18.0 (MPa)^{1/2}” has a possibility of imparting a very high charging property to toner to be positively charged and toner to be negatively charged, but has a very high polarity and a high adhesion. When “the rubber having the SP value not less than 18.0 (MPa)^{1/2}” has a very high polarity, experiments reveal that “the rubber having the SP value not less than 18.0 (MPa)^{1/2}” is very dispersive in the rubber owing to its high polarity and shearing effect of the filler, even though a plurality of fillers is mixed with the rubber component.

Therefore when the vulcanized rubber composition contains “the rubber having the SP value not less than 18.0 (MPa)^{1/2}”, by mixing the three kinds of the fillers (B), (C), and (D) all together with the rubber component, it is possible to effectively restrain the high adhesiveness of “the rubber having the SP value not less than 18.0 (MPa)^{1/2}” taking advantage of the benefit of the rubber having a high polarity.

“The rubber having the SP value not less than 18.0 (MPa)^{1/2}” may be the unconductive rubber little showing conductivity or the ionic-conductive rubber. Because the vulcanized rubber composition of the present invention contains the highly conductive carbon black (C) as its essential component, the vulcanized rubber composition is conductive even though “the rubber having the SP value not less than 18.0 (MPa)^{1/2}” consists of the unconductive rubber. When the unconductive rubber is used as “the rubber having the SP value not less than 18.0 (MPa)^{1/2}”, “the rubber having the SP value not less than 18.0 (MPa)^{1/2}” may be combined with the ionic-conductive rubber or electroconductive agents other than the highly conductive carbon black or an ionic-conductive agent may be added to “the rubber having the SP value not less than 18.0 (MPa)^{1/2}” to impart conductivity thereto.

As the other electroconductive agents, it is possible to list conductive metal oxides such as zinc oxide, potassium titanate, antimony-doped titanium oxide, tin oxide, and graphite; and carbon fibers.

The mixing ratio of the other electroconductive agents can be appropriately selected in consideration of the properties such as the electric resistance value thereof. The mixing ratio of the other electroconductive materials for 100 parts by mass of the rubber component is set to favorably 5 to 40 parts by mass and more favorably 10 to 25 parts by mass. It is preferable that the primary particle diameters of these electroconductive agents are not more than 80 nm.

As “the ionic-conductive rubber”, copolymers such as the polyether copolymers and the epichlorohydrin copolymers containing the ethylene oxide therein are listed.

The ionic-conductive rubber is capable of easily maintaining the uniformity of the electric characteristic and the reproducibility of designed values, but has affinity for water and has a high surface free energy. Consequently the ionic-conductive rubber is liable to get wet and has a high degree of adhesiveness. Thus when the vulcanized rubber composition contains the “ionic-conductive rubber”, it is possible to greatly restrain the adhesiveness thereof which is a defect thereof by applying the present invention.

The following forms are listed as preferable forms of the rubber component (A):

(a) Consists epichlorohydrin copolymer

(b) Consists the combination of chloroprene rubber, epichlorohydrin copolymer or/and polyether copolymer

(c) Consists the combination of chloroprene rubber and NBR

In the above-described forms, the combination (b-1) of the chloroprene rubber and the epichlorohydrin copolymer, the combination (b-2) of the chloroprene rubber, the epichlorohydrin copolymer, and the polyether copolymer, and the combination (c) of the chloroprene rubber and the NBR are especially favorable.

In combining not less than two kinds of rubbers with each other as the rubber component (A), the mixing ratio among them is appropriately selected.

For example, (b-1) in combining the chloroprene rubber and the epichlorohydrin copolymer with each other, supposing that the total mass of the rubber component (A) is 100 parts by mass, the content of the epichlorohydrin copolymer is set to 5 to 95 parts by mass, favorably 20 to 80 parts by mass, and more favorably 20 to 50 parts by mass, and the content of the chloroprene rubber is set to 5 to 95 parts by mass, favorably 20 to 80 parts by mass, and more favorably 50 to 80 parts by mass.

(c) In combining the chloroprene rubber and the NBR with each other, supposing that the total mass of the rubber component (A) is 100 parts by mass, the content of the NBR is set to 5 to 95 parts by mass, favorably 20 to 80 parts by mass, and more favorably 20 to 50 parts by mass, and the content of the chloroprene rubber is set to 5 to 95 parts by mass, favorably 20 to 80 parts by mass, and favorably 50 to 80 parts by mass.

As the epichlorohidrin copolymer, it is possible to list an epichlorohidrin homopolymer, an epichlorohidrin-ethylene oxide copolymer, an epichlorohidrin-propylene oxide copolymer, an epichlorohidrin-allyl glycidyl ether copolymer, epichlorohidrin-ethylene oxide-allyl glycidyl ether copolymer, an epichlorohidrin-propylene oxide-allyl glycidyl ether copolymer, and epichlorohidrin-ethylene oxide-propylene oxide-allyl glycidyl ether copolymer.

As the epichlorohidrin copolymer, compounds containing the ethylene oxide is preferable. The epichlorohidrin copolymer containing the ethylene oxide at not less than 30 mol % nor more than 95 mol %, favorably not less than 55 mol % nor more than 95 mol %, and more favorably not less than 60 mol % nor more than 80 mol % is especially preferable. The ethylene oxide has an action of decreasing the specific volume resistance value of the copolymer. When the ethylene oxide is contained in the copolymer at less than 30 mol %, the ethylene oxide decreases the specific volume resistance value of the polymer to a low degree. On the other hand, when the ethylene oxide is contained in the copolymer at more than 95 mol %, the ethylene oxide crystallizes and thus a segment motion of the molecular chain thereof is prevented from taking place. Thereby there is a tendency for the specific volume resistance value to rise, the hardness of the vulcanized rubber to rise, and the viscosity of the rubber to rise before it is vulcanized.

As the epichlorohidrin copolymer, it is especially preferable to use an epichlorohidrin (EP)-ethylene oxide (EO)-allyl glycidyl ether (AGE) copolymer. As the content ratio among the EO, the EP, and the AGE in the epichlorohidrin copolymer, EO:EP:AGE is favorably 30 to 95 mol %:4.5 to 65 mol %:0.5 to 10 mol % and more favorably 60 to 80 mol %:15 to 40 mol %:2 to 6 mol %.

As the epichlorohidrin copolymer, it is possible to use an epichlorohidrin (EP)-ethylene oxide (EO) copolymer. As the content ratio between the EO and the EP, EO:EP is favorably 30 to 80 mol %:20 to 70 mol % and more favorably 50 to 80 mol %:20 to 50 mol %.

When the rubber component (A) contains the epichlorohidrin copolymer, the mixing ratio thereof for 100 parts by mass of the rubber component (A) is favorably not less than 5 parts by mass, more favorably not less than 15 parts by mass, and most favorably not less than 20 parts by mass.

The chloroprene rubber is polymer of chloroprene and is produced by emulsion polymerization of chloroprene. In dependence on the kind of a molecular weight modifier, the chloroprene rubber is classified into a sulfur-modified type and a sulfur-unmodified type.

The chloroprene rubber of the sulfur-modified type is formed by plasticizing a polymer resulting from polymerization of sulfur and chloroprene with thiuram disulfide or the like so that the resulting chloroprene rubber of the sulfur-modified type has a predetermined Mooney viscosity. The chloroprene rubber of the sulfur-unmodified type includes a mercaptan-modified type and a xanthogen-modified type. Alkyl mercaptans such as n-dodecyl mercaptan, tert-dodecyl mercaptan, and octyl mercaptan are used as the molecular weight modifier for the mercaptan-modified type. Alkyl xanthogen compounds are used as the molecular weight modifier for the xanthogen-modified type.

In dependence on a crystallization speed of generated chloroprene rubber, the chloroprene rubber is classified into an intermediate crystallization speed type, a slow crystallization speed type, and a fast crystallization speed type.

The chloroprene rubber of both the sulfur-modified type and the sulfur-unmodified type can be used in the present invention. But it is preferable to use the chloroprene rubber of the sulfur-unmodified type of the slow crystallization speed type.

When the rubber component (A) contains the chloroprene rubber, the mixing ratio thereof for 100 parts by mass of the rubber component (A) can be selected in the range of not less than 1 part by mass and less than 100 parts by mass. In view of the effect of imparting electrostatic charging property to the toner, it is favorable that the rubber component (A) contains not less than 5 parts by mass of the chloroprene rubber and more favorable that the rubber component (A) contains not less than 10 parts by mass of the chloroprene rubber to make the rubber uniform. As the upper limit of the mixing ratio of the chloroprene rubber, it is favorable that the rubber component (A) contains not more than 80 parts by mass and more favorable that the rubber component (A) contains not more than 60 parts by mass.

As the NBR, it is possible to use any of low-nitrile NBR containing not more than 25% of the acrylonitrile, intermediate-nitrile NBR containing the acrylonitrile in the range of 25 to 31%, intermediate/high nitrile NBR containing the acrylonitrile in the range of 31 to 36%, and high-nitrile NBR containing not less than 36% of the acrylonitrile.

In the present invention, to decrease the specific gravity of the rubber, it is preferable to use the low-nitrile NBR having a small specific gravity. To mix the NBR and the chloroprene rubber with each other favorably, it is preferable to use the intermediate-nitrile NBR or the low-nitrile NBR. More specifically, in view of the SP value, the content of the acrylonitrile in the NBR to be used in the present invention is favorably 15 to 39%, more favorably 17 to 35%, and most favorably 20 to 30%.

It is effective to adjust the electrostatic charging property for the toner by hydrogenating or carboxylating it according to the kind of toner.

When the rubber component (A) contains the NBR, the mixing ratio thereof for 100 parts by mass of the rubber component (A) is favorably 5 to 65 parts by mass, more favorably 10 to 65 parts by mass, and most favorably 20 to 50 parts by mass. When the positively charged toner is used, the charged amount of the toner decreases. Thus the content of the NBR is preferably not more than 65 parts by mass. To refrain the rise of the hardness of the rubber and substantially obtain the effect of decreasing the dependence of the rubber on temperature, the content of the NBR is preferably not less than 5 parts by mass.

Components, other than the rubber component, which are contained in the vulcanized rubber are described below.

A vulcanizing agent for vulcanizing the rubber component is contained in the vulcanized rubber composing the vulcanized rubber composition.

As the vulcanizing agent, it is possible to use a sulfur-based vulcanizing agent, a thiourea-based vulcanizing agent, triazine derivative-based vulcanizing agent, peroxides, and monomers. These vulcanizing agents can be used singly or in combination of two or more of them. As the sulfur-based vulcanizing agent, it is possible to use powdery sulfur, organic sulfur-containing compounds such as tetramethylthiuram disulfide, N,N-dithiobismorpholine, and the like. As the thiourea-based vulcanizing agent, it is possible to use tetramethylthiourea, trimethylthiourea, ethylenethiourea, and thioureas shown by (CₙH₂ₙ₊₁NH)₂C═S (n=integers 1 through 10). As the peroxides, benzoyl peroxide is exemplified.

The mixing ratio of the vulcanizing agent for 100 parts by mass of the rubber component (A) is set to favorably not less than 0.2 nor more than 5 parts by mass and more favorably not less than 1 nor more than 3 parts by mass.

It is preferable to use the sulfur and the thioureas in combination as the vulcanizing agent.

The mixing ratio of the sulfur for 100 parts by mass of the rubber component (A) is favorably not less than 0.1 parts by mass nor more than 5.0 parts by mass and more favorably not less than 0.2 parts by mass nor more than 2 parts by mass. When the mixing amount of the sulfur for 100 parts by mass of the rubber component (A) is less than 0.1 parts by mass, the vulcanizing speed of the entire rubber composition is slow and thus the productivity thereof is low. On the other hand, when the mixing amount of the sulfur for 100 parts by mass of the rubber component (A) is more than 5.0 parts by mass, there is a possibility that the compression set of the rubber composition is high, and the sulfur and an accelerating agent bloom.

The mixing ratio of the thioureas for 100 g of the rubber component (A) is not less than 0.0001 mol nor more than 0.0800 mol, more favorably not less than 0.0009 mol nor more than 0.0800 mol, and most favorably not less than 0.0015 mol nor more than 0.0400 mol. By mixing the thioureas with the rubber component (A) in the above-described range, blooming and the contamination of other members such as the photosensitive drum hardly occur, and further the molecular motion of the rubber is hardly inhibited. Thus the rubber composition is allowed to have a low electric resistance value. As the crosslinking density is increased by increasing the mixing amount of the thioureas, the electric resistance value of the rubber composition can be decreased that much. That is, when the mixing ratio of the thioureas for 100 g of the rubber component (A) is less than 0.0001 mol, it is difficult to improve the compression set of the rubber composition. To effectively lower the electric resistance value of the rubber composition, it is preferable to mix not less than 0.0009 mol of the thioureas with 100 g of the rubber component. On the other hand, when the mixing amount of the thioureas for 100 g of the rubber component (A) is more than 0.0800 mol, the thioureas bloom from the surface of the rubber composition, thus contaminating other members such as the photosensitive drum and deteriorating the mechanical properties of the rubber composition such as a breaking extension to a high extent.

In dependence on the kind of the vulcanizing agent, a known vulcanizing accelerating agent or a known vulcanizing accelerating assistant agent may be mixed with the rubber component.

When the rubber component (A) contains the rubber having the chlorine atoms, it is preferable that the rubber component (A) contains an acid-accepting agent. By adding the acid-accepting agent to the rubber component (A), it is possible to prevent chlorine gas generated in a vulcanizing operation from remaining behind and the other members from being contaminated.

As the acid-accepting agent, it is possible to use various substances acting as acid acceptors. As the acid-accepting agent, hydrotalcites or magnesium oxide can be favorably used because they are excellent in dispersibility. The hydrotalcites are especially favorable. It is possible to obtain a high acid-accepting effect by using the hydrotalcites in combination with magnesium oxide or potassium oxide. Thereby it is possible to securely prevent other members from being contaminated.

The mixing amount of the acid-accepting agent for 100 parts by mass of the rubber component (A) is favorably not less than 1 nor more than 10 parts by mass and more favorably not less than 1 nor more than 5 parts by mass. The mixing amount of the acid-accepting agent for 100 parts by mass of the rubber component (A) is favorably not less than 1 part by mass to allow the acid-accepting agent to effectively display the effect of preventing a vulcanizing operation from being inhibited and the other members from being contaminated. The mixing amount of the acid-accepting agent for 100 parts by mass of the rubber component (A) is favorably not more than 10 parts by mass to prevent the hardness of the conductive rubber composition from increasing.

In addition to the above-described components, the rubber composition may contain the following additives unless the use thereof is not contradictory to the object of the present invention: fillers other than the fillers (B), (C), and (D), a softening agent, a deterioration prevention agent (antioxidant, age resister), a scorch retarder, an ultraviolet ray absorber, a lubricant, a pigment, an antistatic agent, a fire retarding agent, a neutralizer, a core-forming agent, a foaming agent, a foam prevention agent, and a crosslinking agent. But it is preferable that the rubber composition does not contain the softening agent to prevent the toner and other members such as the photosensitive drum from being contaminated by bleeding. When the rubber composition contains the antioxidant, it is preferable to appropriately select the mixing ratio thereof to progress the formation of the oxide film to be made on the surface of the toner-transporting portion.

The method of producing the conductive roller of the present invention is described below.

After components contained in the vulcanized rubber composition composing the toner-transporting portion are kneaded by using a mixing apparatus such as a kneader, a roller, a Banbury mixer or the like, a mixture is tubularly preformed by using a rubber extruder. The preform is vulcanized.

The optimum vulcanizing time period should be set by using a vulcanization testing rheometer (for example, Curust meter). To prevent the contamination of other members of the electrophotographic apparatus and reduce the compression set of the conductive rubber composition, it is preferable to set conditions in which a sufficient vulcanization amount is obtained to a possible highest extent. More specifically, the vulcanizing temperature is set to favorably 100 to 220° C. and more favorably 120 to 180° C. The vulcanizing period of time is set to favorably 15 to 120 minutes and more favorably 30 to 90 minutes.

After the step of vulcanizing the preform finishes, a core is inserted into the hollow portion of the preform and bonded thereto. Thereafter the preform is cut to a necessary size. It is preferable to abrade the surface of the outermost layer forming the toner-transporting portion to a mirror-like surface finish. The surface roughness Rz of the abraded surface of the outermost layer is set favorably to the range of 1 to 8 μm.

Thereafter the roller is washed with water. As desired, the surface of the toner-transporting portion is irradiated with ultraviolet rays or exposed to ozone to form the oxide film thereon.

By forming the oxide film on the surface of the toner-transporting portion, it is possible to decrease the coefficient of friction of the surface of the roller according to the kind of toner and thereby physically improve the toner-transporting portion in the performance of departing the toner therefrom.

In forming the oxide film with ultraviolet rays, it is preferable to irradiate the surface of the toner-transporting portion with the ultraviolet rays having a wavelength of 100 nm to 400 nm and favorably 100 nm to 300 nm for 30 seconds to 30 minutes and favorably one to 10 minutes, although the wavelengths of the ultraviolet rays vary according to the distance between the surface of the toner-transporting portion and an ultraviolet ray irradiation lamp and the kind of rubber. It is preferable to set the energy of the ultraviolet rays to 500 to 4000 mJ/cm².

It is preferable that the conductive roller of the present invention is used for an image-forming mechanism such as a laser beam printer, an ink jet printer, a copying machine, a facsimile, an ATM, and the like of the electrophotographic apparatuses of office automation appliances.

It is especially preferable to use the conductive roller for a toner-transporting portion of a developing roller for transporting unmagnetic one-component toner, a toner supply roller, a cleaning roller, a charging roller, a transfer roller, and the like and members that contact toner. In this case, because at least the outermost layer of the toner-transporting portion is made of the vulcanized rubber composition, it is possible to easily obtain the uniformity of the electrical property and repeated reproducibility of designed values at a low cost.

The conductive roller of the present invention is preferably used as the developing roller for transporting the unmagnetic one-component toner to the photosensitive drum. The developing method used in the image-forming mechanism of the electrophotographic apparatus is classified into a contact type and a non-contact type in terms of the relation between the photosensitive drum and the developing roller. The conductive roller of the present invention can be utilized in both types. It is preferable that when the conductive roller of the present invention is used as the developing roller, it is in contact with the photosensitive drum.

The conductive roller of the present invention may be composed of one layer of the toner-transporting portion, made of the vulcanized rubber composition, constructing the outermost layer thereof or two or more layers made of different compositions. It is preferable to compose the conductive roller of only the toner-transporting portion because it is possible to easily produce the conductive roller at a low cost and easily reproduce the design at a low cost. Thus this construction is preferable from the standpoint of production efficiency.

In using the conductive roller of the present invention for the toner-transporting portion of the developing roller or the like, it is preferable to provide the conductive roller with a sealing member for preventing the leak of toner. In addition to the sealing member for preventing the leak of toner, “the sealing member” includes members that slidingly contact the peripheral surface of the conductive roller.

The electric resistance value of the conductive roller of the present invention at a temperature of 23° C. and a relative humidity of 55% is not more than 10⁹ and favorably not more than 10⁸Ω, when a voltage of 5V is applied thereto. The toner supply efficiency and the like are maintained in this range to prevent the voltage of the developing roller from dropping when the toner is transferred from the developing roller to the photosensitive drum and prevent a defective image from being generated because the toner cannot be securely transported from the developing roller to the photosensitive drum. When the electric resistance value of the conductive roller is not more than 10⁷Ω, the conductive roller can be used in various conditions and is thus very useful.

To restrain the generation of the defective image by controlling the intensity of electric current so that the possibility of discharge to other members such as the photosensitive drum with which the conductive roller contacts is eliminated, the electric resistance value of the conductive roller is favorably not less than 10³Ω and more favorably not less than 10⁵Ω. When the conductive roller of the present invention is used as the developing roller, the electric resistance value thereof is in the range of 10⁴Ω to 10⁷Ω.

The electric resistance value of the conductive roller is measured by the method described in the examples of the present invention.

As described above, the toner-transporting portion of the conductive roller of the present invention is composed of the vulcanized rubber composition essentially containing the rubber component (A), the weakly conductive carbon black (B), the highly conductive carbon black (C), and the inorganic filler (D) consisting of not less than one kind of the metal oxides selected from among the specific metal oxides. The fillers (B), (C), and (D) are mixed with the rubber component (A) at the specific amount respectively. Therefore it is possible to simultaneously satisfy all of “the decrease of adhesive force of toner (transport amount of toner)”, “the charged amount of toner and maintenance thereof”, and “the maintenance of proper degree of print density” which are the contradictory performances. Moreover, because the fillers (B), (C), and (D) show excellent dispersibility, it is possible to adjust the mixing amount thereof so that the fillers (B), (C), and (D) are used in a comparatively small amount and prevent the hardness of the conductive roller from increasing.

### BRIEF DESCRIPTION OF THE DRAWINGS

FIG. 1 is a schematic view showing a developing roller of the present invention.

FIG. 2 shows a method of measuring the electric resistance of the conductive roller of the present invention.

### EXPLANATION OF REFERENCE NUMERAL AND SYMBOLS

1 toner-transporting portion
2 core
3 sealing portion
4 toner
10 conductive roller

### DETAILED DESCRIPTION OF THE PREFERRED EMBODIMENTS

The embodiments of the present invention are described below with reference to the drawings.

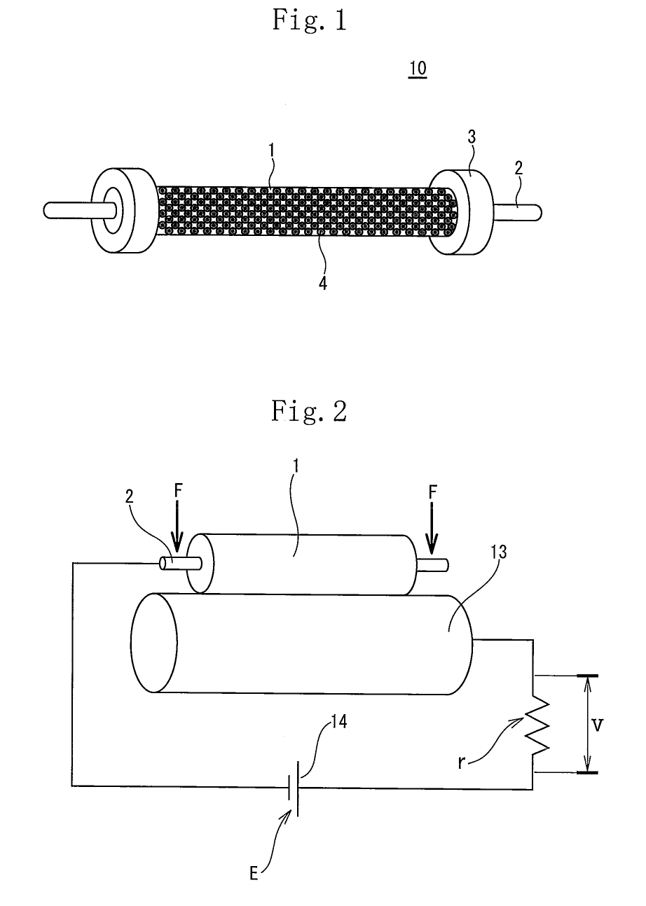

A conductive roller 10 of the present invention is used as a developing roller for transporting an unmagnetic one-component toner 4 to a photosensitive drum. As shown in FIG. 1, the conductive roller 10 has a toner-transporting portion 1 constructed of a vulcanized rubber composition, columnar core (shaft) 2 inserted into a hollow portion of the conductive roller 10 by press fit; and a sealing portion 3 for preventing leak of the toner.

The cylindrical toner-transporting portion 1 has a thickness of 0.5 mm to 15 mm and favorably 3 to 15 mm. The reason the thickness of the toner-transporting portion 1 is set to 0.5 mm to 15 mm is as follows: If the thickness of the toner-transporting portion 1 is less than 0.5 mm, it is difficult to obtain an appropriate nip. If the thickness of the toner-transporting portion 1 is more than 15 mm, the toner-transporting portion 1 is so large that it is difficult to make the developing roller 10 small and lightweight.

The core 2 is made of metal such as aluminum, aluminum alloy, SUS or iron or ceramics. The toner-transporting portion 1 and the core 2 are bonded to each other with a conductive adhesive agent.

The sealing portion 3 is made of nonwoven cloth such as Teflon (registered trademark) or a sheet.

The vulcanized rubber composition forming the toner-transporting portion 1 contains 100 parts by mass of the rubber component (A) mixed with not less than 1 nor more than 20 parts by mass of the weakly conductive carbon black (B) having a large particle diameter not less than 80 nm nor more than 500 nm, not less than 5 nor more than 30 parts by mass of the highly conductive carbon black (C) having a small particle diameter not less than 18 nm nor more than 80 nm, and not less than 1 nor more than 40 parts by mass of the inorganic filler (D) consisting of not less than one kind of metal oxide selected from among a group of titanium oxide, alumina, and silica. The total of the mixing amount of the weakly conductive carbon black (B), that of the highly conductive carbon black (C), and that of the inorganic filler (D) is so adjusted as to be not less than 5 parts by mass nor more than 60 parts by mass for 100 parts by mass of the rubber component (A).

Supposing that the total mass of the rubber component (A) is 100 parts by mass, as the rubber component (A), a blended rubber composed of 50 to 80 parts by mass of chloroprene rubber and 20 to 50 parts by mass of an epichlorohydrin copolymer or a blended rubber containing 50 to 80 parts by mass of the chloroprene rubber and 20 to 50 parts by mass of NBR is used.

As the epichlorohydrin copolymer, an epichlorohydrin (EP)-ethylene oxide (EO)-allyl glycidyl ether (AGE) copolymer is used. As the content ratio among the EO, the EP, and the AGE of the epichlorohydrin copolymer used in the embodiment, EO:EP:AGE is set to 60 to 80 mol %:15 to 40 mol %:2 to 6 mol %.

As the NBR, low nitrile mixable with the chloroprene rubber is used.

As the weakly conductive carbon black (B), SRF, FT or MT having a particle diameter of not less than 100 nm nor more than 250 nm is used. The SRF, the FT or the MT spherical or approximately spherical is used. The SRF, the FT or the MT used in the embodiment has an iodine adsorption amount of 10 to 40 mg/g and a DBP oil absorption amount of 25 to 90 ml/100 g.

As the highly conductive carbon black (C), FEF, ISAF, SAF or HAF carbon having a particle diameter of not less than 18 nm nor more than 80 nm is used.

As the inorganic filler (D) consisting of the metal oxide, at least one substance selected from among the titanium oxide, the alumina, and the silica is used.

As the titanium oxide, the titanium oxide of the rutile type containing particles having a primary diameter of 0.3 to 0.5 μm as its main component is used.

It is preferable to use the alumina containing particles having a primary diameter of not more than 1 μm at not less than 80% and the alumina containing particles having a primary diameter of not more than 0.5 μm at not less than 50%.

The silica used in the embodiment has an average primary particle diameter of 10 to 500 nm and a BET specific surface area of 30 to 300 m²/g.

Sulfur and thioureas are used in combination as a vulcanizing agent. Not less than 0.1 parts by mass nor more than 5.0 parts by mass of the sulfur and not less than 0.0001 mol nor more than 0.0800 mol of the thioureas are mixed with 100 parts by mass of the rubber component (A). In this embodiment, ethylene thiourea is used as the thioureas.

As an acid-accepting agent, not less than 1 nor more than 10 parts by mass of hydrotalcite is mixed with 100 parts by mass of the rubber component (A),

By composing the vulcanizing agent consisting of the sulfur and the thioureas, it is possible to increase the vulcanizing speed of the entire rubber composition and improve the productivity, make the properties of the rubber composition such as the compression set thereof preferable, prevent the occurrence of blooming and contamination of other members, and little prevent the molecular motion of the rubber. Thereby the rubber composition is allowed to have a low electric resistance value. In addition, by adding the hydrotalcite to the rubber component, it is possible to prevent chlorine of the epichlorohydrin copolymer from inhibiting vulcanization.

The method of producing the conductive roller 10 shown in FIG. 1 is described below.

After components composing the toner-transporting portion 1 are kneaded by using a mixing apparatus such as a kneader, a roller, a Banbury mixer or the like, a mixture thereof is tubularly preformed by using a rubber extruder. Thereafter the preform is vulcanized. The optimum vulcanizing time period should be set by using a vulcanization testing rheometer (for example, Curust meter). To decrease the contamination of other members and the compression set, conditions are so set as to obtain a possible sufficient vulcanization amount. More specifically, the vulcanizing temperature is set to 100 to 220° C. (preferably 120 to 180° C.) The vulcanizing period of time is set to 15 to 120 minutes (preferably 30 to 90 minutes).

After the vulcanizing step finishes, the core 2 is inserted into the hollow portion of the preform and bonded thereto with an adhesive agent. After the preform is cut to a necessary size, the surface of the toner-transporting portion 1 is abraded to a mirror-like surface finish. The surface roughness Rz of the toner-transporting portion 1 is set to the range of 1 to 8 μm.

After the roller is washed with water, an oxide film is formed on the surface of the toner-transporting portion 1 as desired. In forming the oxide film, by using an ultraviolet ray irradiation lamp, the surface of the conductive roller is irradiated with ultraviolet rays (wavelength: 184.9 nm and 253.7 nm) at intervals of 90 degrees in its circumferential direction for five minutes with the ultraviolet ray irradiation lamp spaced at 10 cm from the conductive roller. The conductive roller is rotated by 90 degrees four times to form the oxide film on its entire peripheral surface (360 degrees).

The electric resistance value of the conductive roller produced by the above-described method in environment where a temperature is set to 23° C. and a relative humidity is set to 55% is set to not more than 10³ to 10⁷Ω (favorably 10⁴ to 10⁷Ω) when a voltage of 5V is applied thereto. The hardness of the conductive roller measured in conformity to the durometer hardness test type A specified in JIS K 6253 is 40 to 80 degrees (preferably 50 to 80 degrees).

Examples of the present invention and comparison examples are described below.

### EXAMPLES 1 THROUGH 18 AND COMPARISON EXAMPLES 1, 2

The components (numerical values shown in table 1 indicate part by mass) shown in table 1, 100 parts by mass of a rubber component, 0.75 parts by mass of powdery sulfur, 0.75 parts by mass of ethylene thiourea, and 5 parts by mass of hydrotalcite were kneaded by using a Banbury mixer. Thereafter the kneaded components were extruded by a rubber extruder to obtain a tube of each of the examples and the comparison examples having an outer diameter of φ22 mm and an inner diameter of φ9 mm to φ9.5 mm.

Each tube was mounted on a shaft having a diameter of φ8 mm for vulcanizing use. After the rubber component was vulcanized in a vulcanizing can for one hour at 160° C., the tube was mounted on a shaft, having a diameter of φ10 mm, to which a conductive adhesive agent was applied. The tube and the shaft were bonded to each other in an oven at 160° C. After the ends of the tube were cut, traverse abrasion was carried out by using a cylindrical abrading machine. Thereafter the surface of the tube was abraded to a mirror-like surface finish. The surface roughness Rz of the tube was set to the range of 3 to 5 μm.

The surface roughness Rz was measured in accordance with JIS B 0601 (1994). As a result, a conductive roller of each of the example and the comparison example having a diameter of φ20 mm (tolerance: 0.05) was obtained.

After the surface of each of the conductive rollers was washed with water, the surface thereof was irradiated with ultraviolet rays to form an oxide film thereon.

By using an ultraviolet ray irradiation lamp (“PL21-200” produced by SEN LIGHTS CO.), the surface of each conductive roller was irradiated with ultraviolet rays (wavelength: 184.9 nm and 253.7 nm) at intervals of 90 degrees in its circumferential direction for five minutes with the ultraviolet ray irradiation lamp spaced at 10 cm from the conductive roller. The conductive roller was rotated by 90 degrees four times to form the oxide film on its entire peripheral surface (360 degrees).

TABLE 1

| | | Exam- | Exam- | Exam- | Exam- | Exam- | Exam- | Exam- | Exam- | Exam- | Exam- |
|---|---|---|---|---|---|---|---|---|---|---|---|
| | | ple 1 | ple 2 | ple 3 | ple 4 | ple 5 | ple 6 | ple 7 | ple 8 | ple 9 | ple 10 |
| Rubber | Chloroprene | 65 | 65 | 65 | 65 | 65 | 65 | 65 | 65 | 65 | 65 |
| component (A) | rubber | | | | | | | | | | |
| | GECO | 35 | 35 | 35 | 35 | 35 | 35 | 35 | 35 | 35 | 35 |
| | NBR | | | | | | | | | | |
| Weakly conductive carbon | | 5 | 5 | 5 | 5 | 5 | 5 | 1 | 2.5 | 15 | 20 |
| black (B) | | | | | | | | | | | |
| Highly conductive carbon | | 5 | 10 | 15 | 20 | 25 | 30 | 15 | 15 | 15 | 15 |
| black (C) | | | | | | | | | | | |
| Inorganic | titanium | 5 | 5 | 5 | 5 | 5 | 5 | 5 | 5 | 5 | 5 |
| filler (D) | oxide | | | | | | | | | | |
| | Alumina | | | | | | | | | | |
| | Silica | | | | | | | | | | |

| | | | | | | | | | | |
|---|---|---|---|---|---|---|---|---|---|---|
| Total of mixing amounts | 15 | 20 | 25 | 30 | 35 | 40 | 21 | 22.5 | 35 | 40 |
| of (B), (C), and (D) | | | | | | | | | | |
| Surface treatment (UV | Treated | Treated | Treated | Treated | Treated | Treated | Treated | Treated | Treated | Treated |
| irradiation 5 minutes) | | | | | | | | | | |
| Electric resistance value | 6.4 | 6.4 | 5.8 | 4.1 | 3.2 | Up to 3 | 6.2 | 6.2 | 5.5 | 5 |
| (applied voltage: 5 V, | | | | | | | | | | |
| 23° c., 55%: logΩ) | | | | | | | | | | |
| Hardness (JIS A) | 60 | 63 | 67 | 71 | 75 | 79 | 65 | 66 | 71 | 73 |
| Transmission density of | 1.85 | 1.87 | 1.91 | 1.90 | 1.91 | 1.90 | 1.94 | 1.93 | 1.84 | 1.62 |
| printing of initial (100th) | ◯ | ◯ | ⊚ | ⊚ | ⊚ | ⊚ | ⊚ | ⊚ | ◯ | ◯ |
| black solid image: C100 | | | | | | | | | | |
| Transmission density of | 1.79 | 1.83 | 1.90 | 1.90 | 1.90 | 1.90 | 1.93 | 1.93 | 1.82 | 1.80 |
| printing of 2000th black | | | | | | | | | | |
| solid image: C2000 | | | | | | | | | | |
| Change rate of density | 97% | 98% | 99% | 100% | 99% | 100% | 99% | 100% | 99% | 99% |
| [(C2000/C100) × 100(%)] | ◯ | ◯ | ⊚ | ⊚ | ⊚ | ⊚ | ⊚ | ⊚ | ⊚ | ⊚ |
| Transport amount of toner | 0.39 | 0.39 | 0.34 | 0.31 | 0.32 | 0.41 | 0.39 | 0.38 | 0.34 | 0.40 |
| (mg/cm2) | ⊚ | ⊚ | ⊚ | ⊚ | ⊚ | ⊚ | ⊚ | ⊚ | ⊚ | ◯ |
| Durability of image (number | 13500 | 14000 | 14500 | 14500 | 14500 | 14000 | 13000 | 14000 | 15000 | 15000 |
| of sheets on which defective | ◯ | ⊚ | ⊚ | ⊚ | ⊚ | ⊚ | ⊚ | ⊚ | ⊚ | ⊚ |
| image was generated) | | | | | | | | | | |
| Over-all judgement | ⊚~◯ | ⊚~◯ | ⊚ | ⊚ | ⊚ | ⊚~◯ | ⊚~◯ | ⊚ | ⊚ | ⊚~◯ |

TABLE 2

| | | Example | Example | Example | Example | Example | Example | Example | Example |
|---|---|---|---|---|---|---|---|---|---|
| | | 11 | 12 | 13 | 14 | 15 | 16 | 17 | 18 |
| Rubber | Chloroprene rubber | 65 | 65 | 65 | 65 | 65 | 65 | 65 | 65 |
| component (A) | GECO | 35 | 35 | 35 | 35 | 35 | 35 | 35 | |
| | NBR | | | | | | | | 35 |
| Weakly conductive carbon black (B) | | 5 | 5 | 5 | 5 | 5 | 5 | 5 | 5 |
| Highly conductive carbon black (C) | | 15 | 15 | 15 | 15 | 15 | 15 | 15 | 15 |
| Inorganic | titanium oxide | 1 | 2.5 | 15 | 20 | 40 | | | 5 |
| filler (D) | Alumina | | | | | | 2.5 | | |
| | Silica | | | | | | | 2.5 | |

| | | | | | | | | |
|---|---|---|---|---|---|---|---|---|
| Total of mixing amounts of (B), (C), | 21 | 22.5 | 35 | 40 | 60 | 22.5 | 22.5 | 25 |
| and (D) | | | | | | | | |
| Surface treatment (UV irradiation | Treated | Treated | Treated | Treated | Treated | Treated | Treated | Treated |
| 5 minutes) | | | | | | | | |
| Electric resistance value | 5.8 | 5.8 | 6 | 6 | 6 | 5.8 | 5.8 | 6.2 |
| (applied voltage: 5 V, 23° c., 55%: logΩ) | | | | | | | | |
| Hardness (JIS A) | 65 | 66 | 71 | 73 | 80 | 66 | 70 | 63 |
| Transmission density of printing of | 1.91 | 1.91 | 1.91 | 1.91 | 1.88 | 1.85 | 1.78 | 1.85 |
| initial(100th) black solid image: C100 | ⊚ | ⊚ | ⊚ | ⊚ | ◯ | ◯ | Δ | ◯ |
| Transmission density of printing of | 1.90 | 1.90 | 1.90 | 1.90 | 1.84 | 1.84 | 1.78 | 1.84 |
| 2000th black solid image: C2000 | | | | | | | | |
| Change rate of density | 99% | 99% | 99% | 99% | 98% | 99% | 100% | 99% |
| [(C2000/C100) × 100(%)] | ⊚ | ⊚ | ⊚ | ⊚ | ◯ | ⊚ | ⊚ | ⊚ |
| Transport amount of toner | 0.38 | 0.36 | 0.34 | 0.34 | 0.34 | 0.30 | 0.27 | 0.39 |
| (mg/cm2) | ⊚ | ⊚ | ⊚ | ⊚ | ⊚ | ⊚ | ⊚ | ⊚ |
| Durability of image (number of sheets | 14500 | 14500 | 14500 | 14500 | 12500 | 14500 | 15000 | 14000 |
| on which defective image was | ⊚ | ⊚ | ⊚ | ⊚ | Δ | ⊚ | ⊚ | ⊚ |
| generated) | | | | | | | | |
| Over-all judgement | ⊚ | ⊚ | ⊚ | ⊚ | ◯ | ⊚~◯ | ⊚~◯ | ⊚~◯ |

TABLE 3

| | | Compar- | Compar- |
|---|---|---|---|
| | | ison 1 | ison 2 |
| Rubber | Chloroprene rubber | 65 | 65 |
| component (A) | GECO | 35 | 35 |
| | NBR | | |
| Weakly conductive carbon black (B) | | 40 | 40 |
| Highly conductive carbon black (C) | | 0 | 0 |
| Inorganic | titanium oxide | 0 | 10 |
| filler (D) | Alumina | | |
| | Silica | | |

| | | |
|---|---|---|
| Total of mixing amounts of (B), (C), and(D) | 40 | 50 |
| Surface treatment (UV irradiation 5 minutes) | Treated | Treated |
| Electric resistance value | 6.4 | 6.4 |
| (applied voltage: 5 V, 23° c., 55%: logΩ) | | |
| Hardness (JIS A) | 68 | 72 |
| Transmission density of printing of | 1.81 | 1.81 |
| initial(100th) black solid image: C100 | ο | ο |
| Transmission density of printing of | 1.71 | 1.81 |
| 2000th black solid image: C2000 | | |
| Change rate of density [(C2000/C100) × 100(%)] | 94% | 100% |
| | Δ | ⊚ |
| Transport amount of toner(mg/cm2) | 0.50 | 0.42 |
| | Δ | ο |
| Durability of image (number of sheets | 12000 | 11000 |
| on which defective image was generated) | Δ | X |
| Over-all judgement | Δ | Δ |

As the components of the conductive roller of each of the examples and the comparison examples, the following substances were used:
Chloroprene rubber: “Showprene WRT” (commercial name) produced by Showa Denko K.K.•GECO (Epichlorohydrin copolymer): “Epion ON301” (commercial name) produced by DAISO CO., LTD. [EO (ethylene oxide/EP (epichlorohydrin)/AGE (allyl glycidyl ether)=73 mol %/23 mol %/4 mol %]
NBR (acrylonitrile butadiene rubber): “Nipporu DN401LL” (commercial name) produced by Zeon Corporation (low nitrile NBR; content of acrylonitrile: 18%)
Weakly conductive carbon black (B): “Asahi #8” (commercial name) produced by Asahi Carbon Co., Ltd. (average primary particle diameter: 120 nm, DBP oil absorption amount: 29 ml/100 g, iodine adsorption amount: 14 mg/g)
Highly conductive carbon black (C): “Denkablack” (commercial name) produced by TDK Electronics Co., Ltd. (granular, average diameter: 35 nm)
Titanium oxide: “kronos KR310” (commercial name) produced by Titan Kogyo K.K., (specific gravity: 4.2, particles having diameter of 0.3 to 0.5 μm are main component)
Alumina: “AL-160-SG-1” (commercial name) produced by Showa Denko K.K. (contained particles whose diameter are not more than 1 μm at 91% and particles whose diameter are not more than 500 nm at 64%)
Silica: “Nipseal VN3” (commercial name) produced by Tosoh Silica Corporation (produced by using wet method, primary particle diameter: 16 nm, nitrogen adsorption specific surface area: 170 to 220 m²/g)
Hydrotalcite (acid-accepting agent): “DHT-4A-2” (commercial name) produced by Kyowa Chemical Industry Co., Ltd.
Sulfur: Powdery sulfur
Ethylene thiourea: “Axel 22-S” (commercial name) produced by KAWAGUCHI CHEMICAL INDUSTRY CO., LTD.

The following properties of the conductive roller of each of the examples and the comparison examples were measured. Results and mixing ratios are shown in tables 1 through 3.
Measurement of Electric Resistance of Conductive Roller

To measure the electric resistance of each roller, as shown in FIG. 2, the toner-transporting portion 1 through which the core 2 was inserted was mounted on an aluminum drum 13, with the toner-transporting portion 1 in contact with the aluminum drum 13. A leading end of a conductor, having an internal electric resistance of r (1000), which was connected to a positive side of a power source 14 was connected to one end surface of the aluminum drum 13. A leading end of a conductor connected to a negative side of the power source 14 was connected to one end surface of the toner-transporting portion 1.

A voltage V applied to the internal electric resistance r of the conductor was detected. Supposing that a voltage applied to the apparatus is E, the electric resistance R of the roller is: R=r×E/(V−r). Because the term of −r is regarded as being extremely small, the electric resistance R of the roller can be expressed as R=r×E/V. A load F of 500 g was applied to both ends of the core 2. With the roller being rotated at 30 rpm, the detected voltage V was measured at 100 times during four seconds by applying the voltage E of 5V to the roller. The electric resistance R was computed by using the above equation. The electric resistance of the roller was measured at a temperature of 23° C. and a relative humidity of 55%.

In table 1, the electric resistance values are shown by log₁₀R.
Measurement of Hardness of Roller

The hardness of each conductive roller was measured in conformity to the durometer hardness test type A specified in JIS K 6253.
Evaluation of Print Density

To examine the adherability of toner to the conductive roller, the conductive roller of each of the examples and the comparison examples was mounted on a laser printer (commercially available printer in which positively charged unmagnetic one-component toner was used, recommended number of sheets which can be printed with toner: 7000 sheets) as a developing roller. The performance of each conductive roller was evaluated by setting a toner amount outputted as an image, namely, an amount of the toner deposited on a sheet on which an image was printed, in other words, a print density as the index. The print density can be measured by measuring a transmission density shown below. By carrying out a method described below, the print density was measured on a sheet on which an initial black solid image was printed and on a 2000th sheet on which a black solid image was printed. A density change rate was obtained from each obtained value.
Print Density of Paper on Which Initial Black Solid Image was Printed

After an image was printed at 1% on 100 sheets, a black solid image was printed on a 101st sheet which was set as the sheet on which the initial black solid image was printed. The transmission density was measured by using a reflection transmission densitometer (“Teshikon densitometer RT120/light table LP20” produced by TECHKON Inc.) at given five points on the paper on which the initial black solid image was printed. The average of the measured transmission densities was set as the print density (C100).

The print densities (C100) shown in the tables were evaluated as follows: A print density of C100<1.7 was very thin and was marked by X. A print density of 1.7≦C100<1.8 was thin, but in this range, the conductive roller can be used and was thus marked by Δ. A print density of 1.8≦C100<1.9 was still thin, but was favorable and was thus marked by ∘. A print density of 1.9≦C100<2.0 was optimum and was thus marked by ⊚. A print density of 2.0≦C100<2.1 was thick, but was favorable and was thus marked by ∘.
Print Density of 2,000th Paper on Which Black Solid Image was Printed

After obtaining the sheet on which the initial black solid image was printed, the image was printed at 1% up to a 2000th sheet. Thereafter the black solid image was printed on a 2001st sheet which was set as the 2000th sheet on which the black solid image was printed. The transmission density was measured with a reflection transmission densitometer (“Tecikon densitometer RT120/light table LP20” produced by TECHKON Inc.) at given five points on the 2000th sheet on which the black solid image was printed. The average of the measured transmission densities was set as the print density (C2000).
Change Rate of Density

Based on the following equation, the change rate of the print density was found from the values of C100 and C2000 obtained in the measurement.

Change rate (%) of density=(C2000/C100)×100

As shown in the tables, the print density was evaluated as follows: A print density not more than 90% was marked by X. A print density more than 90 and not more than 95% was marked by Δ. A print density more than 95 and not more than 98% was marked by ∘. A print density more than 98% and not more than 102% was marked by ⊚. A print density more than 102% and not more than 105% was marked by ∘.
Measurement of Transport Amount of Toner

The transport amount of toner was evaluated as described below by using an instrument for measuring the charged amount of toner to examine the relationship between the print density measured in the above-described manner and the toner-transporting performance.

After the black solid image was printed on the 101st sheet, a white solid image was printed on a 102nd sheet. Thereafter a cartridge was removed from the laser printer to suck toner from the developing roller mounted on the cartridge by using a charged amount-measuring machine of absorption type [“Q/M METER Model 210HS-2” (commercial name) produced by Trek Inc.] so that the mass (g) of toner was measured. Based on the following equation, the transport amount of the toner (T100) was computed from obtained values.

Transport amount (mg/cm²) of toner=Mass (mg) of toner/Sucked area (cm²)

It is preferable that the transport amount of the toner is small. More specifically, as shown in the tables, the transport amount of the toner was evaluated as follows: A toner transport amount of T100≧0.6 was marked by X. A toner transport amount of 0.49<T100≦0.59 was marked by Δ. A toner transport amount of 0.39<T100≦0.49 was marked by ∘. A toner transport amount of T100≦0.39 was marked by ⊚.
Evaluation of Durability of Image

After obtaining the 2000th sheet on which the black solid image was printed, the image was printed at 1% to evaluate the durability of the image. A predetermined image was printed each time the image was printed on 500 sheets. In this printing operation, the number of sheets which became black at a portion to be printed in white because toner was placed on the portion to be printed in white was recorded as sheets where a defective image was formed.

A cartridge which had a life not less than the durable number of sheets (namely, 7,000 sheets)×2 (=14,000 sheets) was evaluated to be excellent and was marked by ⊚. A cartridge which had a life not less than 13,000 sheets and less than 14,000 sheets was evaluated to be favorable and was marked by ∘. A cartridge which had a life not less than 12,000 sheets and less than 13,000 sheets was marked by Δ. A cartridge which had a life less than 12,000 was marked by X.

In the conductive roller of the comparison 2 not containing the highly conductive carbon black (C), the toner transport amount was large, and the performance of departing the toner therefrom was unfavorable. Consequently the conductive roller had an inferior development efficiency. The durability of image was also unfavorable.

In the conductive roller of the comparison 1 containing neither the inorganic filler (D) nor the highly conductive carbon black (C), the toner transport amount was large, the performance of departing the toner therefrom was unfavorable, the durability of image was also unfavorable, and the change rate of the print density was as low as 94%. Thus the initial printing density could not be maintained.

In each of the conductive rollers of the examples 1 through 18 containing the weakly conductive carbon black (B), the highly conductive carbon black (C), and the inorganic filler (D) at the mixing ratios falling in the range specified in the present invention, an appropriate print density can be maintained, and in addition the image durability is excellent. It was also found that the toner transport amount was small and that the development efficiency was excellent.

What is claimed is:

1. A conductive roller comprising a toner-transporting portion, made of a vulcanized rubber composition, which is disposed at least on an outermost layer thereof,
wherein said vulcanized rubber composition contains a rubber component (A) mixed with a weakly conductive carbon black (B) having a large particle diameter not less than 80 nm nor more than 500 nm, a highly conductive carbon black (C) having a small particle diameter not less than 18 nm nor more than 80 nm, and an inorganic filler (D) consisting of not less than one kind of a metal oxide selected from among a group of titanium oxide, alumina, and silica, and
a total of a mixing amount of said weakly conductive carbon black (B), that of said highly conductive carbon black (C), and that of said inorganic filler (D) for 100 parts by mass of said rubber component (A) is not less than 15 parts by mass nor more than 60 parts by mass.

2. The conductive roller according to claim 1, wherein 100 parts by mass of said rubber component (A) is mixed with not less than 1 nor more than 40 parts by mass of said weakly conductive carbon black (B), not less than 1 nor more than 40 parts by mass of said highly conductive carbon black (C), and not less than 1 nor more than 40 parts by mass of said inorganic filler (D).

3. The conductive roller according to claim 2, wherein 100 parts by mass of said rubber component (A) is mixed with not less than 1 nor more than 20 parts by mass of said weakly conductive carbon black (B), not less than 5 nor more than 30 parts by mass of said highly conductive carbon black (C), and not less than 1 nor more than 20 parts by mass of said inorganic filler (D), and
said total of said mixing amount of said weakly conductive carbon black (B), that of said highly conductive carbon black (C), and that of said inorganic filler (D) for 100 parts by mass of said rubber component (A) is not less than 15 parts by mass nor more than 40 parts by mass.

4. The conductive roller according to claim 1, wherein a mixing amount of said highly conductive carbon black (C) is set larger than that of said weakly conductive carbon black (B) and not less than that of said inorganic filler (D) consisting of said metal oxide.

5. The conductive roller according to claim 1, wherein said rubber component (A) contains a rubber having chlorine atoms or/and a rubber whose solubility parameter is not less than 18.0 (MPa)^{1/2}.

6. The conductive roller according to claim 1, wherein an ionic conductive rubber is used as said rubber component (A) of said vulcanized rubber composition or an ionic-conductive agent is added to said rubber component (A) to impart ionic conductivity to said rubber component (A).

7. The conductive roller according to claim 1, wherein said inorganic filler (D) is titanium oxide.

8. The conductive roller according to claim 1, which is used as a developing roller for use in a developing device, of an image-forming mechanism of an electrophotographic apparatus, in which an unmagnetic one-component toner is used.

9. The conductive roller according to claim 1, which comprises a toner-transporting portion and a cylindrical core inserted into a hollow portion of said toner-transporting portion by press fit, wherein an oxide film is formed on a surface of said toner-transporting portion by irradiating said surface with ultraviolet rays.
